(19) United States
(12) Patent Application Publication
(10) Pub. No.: US 2009/0252454 A1
(43) Pub. Date: Oct. 8, 2009

(54) Fiber-optic termination with brewster angled tip

(76) Inventor: Francois Chenard, Quebec (CA)

Correspondence Address: Louis Tessier, P.O. Box 54029, Town of Mount-Royal, QC, H3P 3H4, CA

(21) Appl. No.: 12/385,326

(22) Filed: Apr. 6, 2009

Related U.S. Application Data
(60) Provisional application No. 61/064,947, filed on Apr. 4, 2008.

(51) Int. Cl. G02B 6/26

(52) U.S. Cl. 385/31

(57) ABSTRACT

A fiber-optic termination with Brewster angled tip is disclosed, which allows minimizing the reflection loss of a polarized light while maximizing the coupling of the refracted polarized light along the axis of the optical fiber. In a preferred embodiment, the fiber-optic termination has a Brewster angled tip which is free standing in air. The holding fixture may be water cooled to evacuate any heat that can occur at the input end of the optical fiber. Further embodiments include fiber array made of multiple fiber-optic terminations with Brewster angled tips for switching applications for example.

This Application claims priority from U.S. Provisional Patent Application Ser. No. 61/064,947 filed on Apr. 4, 2008

### FIELD OF THE INVENTION

This invention relates to fiber-optic terminations suitable to couple light in and/or out of an optical fiber. More specifically, it is concerned with fiber-optic terminations that use a Brewster angled tip.

### DESCRIPTION OF PRIOR ART

Fiber-optic connectors are specific terminations used to connect a first optical fiber to a second optical fiber or to a device, such as a laser or a detector, for example. They are commonly made by fixing the fiber end in a ferrule with glue and then polishing the total assembly in multiple steps to obtain optical quality surfaces. This is a relatively long process and does not allow for high-power laser beam coupling because the heating of the glue can lead to evaporation and deposition of contaminants on the fiber, causing catastrophic damage to the fiber surface.

Connectors designed such that the fiber is free standing in air have been demonstrated since the early 1980's to allow high-power laser beam coupling. In particular, silica fiber with large core diameter of 50-1000 micron is commonly used to transmit several watts to several kilowatts of laser power. For example, U.S. Pat. No. 4,676,586 and U.S. Pat. No. 5,778,125 disclose two such free standing fiber connectors.

People in the art are well aware of the Fresnel reflection at the optical fiber terminations, defined by R=[(n_{fiber}−nₐᵢᵣ)/(n_{fiber}+nₐᵢᵣ)]², where n_{fiber} is the refractive index of the material of the fiber and nₐᵢᵣ is the refractive index of air. Fresnel reflection is larger as the refractive index of the fiber increases. Methods for reducing the Fresnel reflection include using antireflection (AR) coatings. However AR coatings are relatively expensive multi layers. Furthermore, because of fabrication and material considerations, AR coatings on fiber-optic connectors generally have low laser induced damage threshold and cannot be used efficiently with high-power laser beam.

In spite of a number of developments, there is therefore still a need for improved fiber optic terminations with low Fresnel reflection loss.

The present invention seeks to meet these needs and other needs.

### OBJECTS AND SUMMARY OF THE INVENTION

In accordance with one embodiment of the present invention, there is provided a fiber-optic termination with Brewster angled tip. Advantageously, such a fiber-optic termination minimizes the Fresnel reflection loss of a polarized light and maximizes the coupling of the refracted polarized light along the axis of the optical fiber.

In some embodiments of the invention, the fiber-optic termination with Brewster angled tip includes a tip that is free standing in air.

In some embodiments of the invention, a holding fixture for the fiber-optic termination with Brewster angled tip is water cooled to evacuate heat that can occur at the input end of the optical fiber.

In some embodiments, a fiber array made of multiple fiber-optic terminations with Brewster angled tips is provided.

Other objects, advantages and features of the present invention will become more apparent upon reading of the following non-restrictive description of specific embodiments thereof, given by way of example only with reference to the accompanying drawings.

The present description refers to a number of documents, the content of which is herein incorporated by reference in their entirety.

### BRIEF DESCRIPTION OF THE DRAWINGS

FIG. 1 illustrates an incident polarized light on t a fiber-optic end face at the Brewster angle θ_{B} and refracting along the axis of the optical fiber.

FIG. 2 shows the Fresnel reflection of an incident polarized light on a chalcogenide glass fiber-optic end face versus incident angle for parallel polarization (R parallel) in respect to the plane of incidence.

FIG. 3a and FIG. 3b illustrate embodiments of the fiber-optic termination with Brewster angled tip which is free standing in air.

### DETAILED DESCRIPTION OF THE PREFERRED EMBODIMENTS

The present invention is illustrated in further details by the following non-limiting examples.

Generally stated, the end face of the fiber-optic termination is at an angle allowing minimum reflection of an incoming light, and at the same time refraction of the light along the axis of the optical fiber.

More precisely, the fiber-optic termination has a fiber end face at the Brewster angle in respect to an incoming polarized light, from a laser or another light source for example, and simultaneously has the same fiber end face at an angle such as the refracted polarized light is along the axis of the optical fiber.

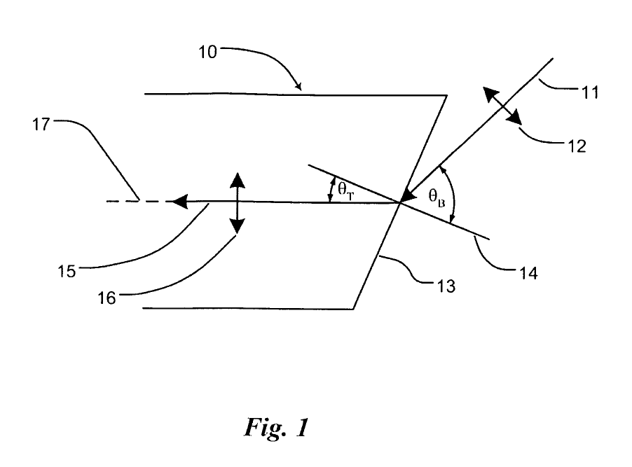

FIG. 1 illustrates one optical fiber 10 with the incident polarized light, designated by arrow 11, having an electric field, designated by double arrow 12, parallel to the plane of incidence, corresponding to the plane formed with an axis 14 perpendicular to the fiber end face 13 and the incident polarized light 11. The incoming polarized light 11 hits the fiber end face 13 at the Brewster angle θ_{B}, defined by (tan θ_{B}=n_{fiber}/nₐᵢᵣ), where n_{fiber} is the refractive index of the material of the fiber and nₐᵢᵣ is the refractive index of the material in which the incoming light propagates (generally air). Such an incident polarized light 11 enters the fiber end face 13 with no reflection. Furthermore, the transmitted polarized light, designated by arrow 15, with electric field, designated by double arrow 16, parallel to the plane of incidence, makes an angle θ_{T} with the axis 14 perpendicular to the fiber end face 13 such as the incoming polarized light 11 is refracted along the axis 17 of the optical fiber 10 according to the law of refraction defined by (nₐᵢᵣ sin θ_{B}=n_{fiber} sin θ_{T}). Thus the fiber-optic termination with the Brewster angled tip simultaneously minimizes the reflection from an incoming polarized light and maximizes coupling of the refracted polarized light along the axis of the optical fiber.

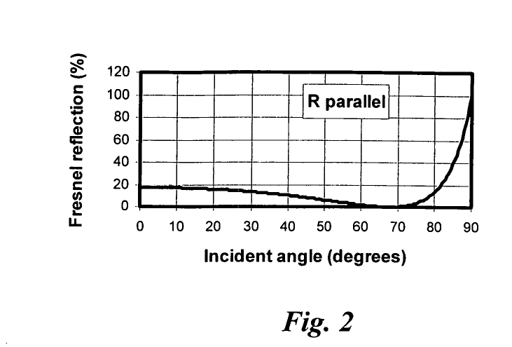

For example, chalcogenide glass fiber can be used to transmit mid-infrared light. Chalcogenide has refractive index of 2,438 at wavelength of 3 microns. The Fresnel reflection R at the air-fiber interface is relatively high at such wavelength, R=17.5%. But if the incident light is polarized, as it is typically for laser sources, then the Brewster angled tip can be used to simultaneously minimize the reflection from an incoming polarized light and to maximize coupling of the refracted polarized light along the axis of the optical fiber. In this example, the Brewster angle θ_{B} is 67.7° and the transmitted angle θ_{T} is 22.3°. Furthermore it must be emphasized that even considering the refractive index n dispersion of the chalcogenide glass with wavelength λ, 2.447<n<2.43 for 1.5 micron<λ<5 micron, the corresponding Brewster angle θ_{B} varies very little as 67.77°<θ_{B}<67.63°. Also FIG. 2 shows the Fresnel reflection at wavelength of 3 micron for an incident polarized light on the chalcogenide glass fiber-optic end face versus incident angle for polarization parallel to the plane of incidence. FIG. 2 clearly shows the minimum Fresnel reflection at the Brewster angle θ_{B}=67.7°, but more importantly, there is a broad range of angles where Fresnel reflection of the incident polarization parallel to the plane of incidence, R parallel, is very low. All the above allows for some tolerances on the incident angle and the mechanical design with the Brewster angled tip solution.

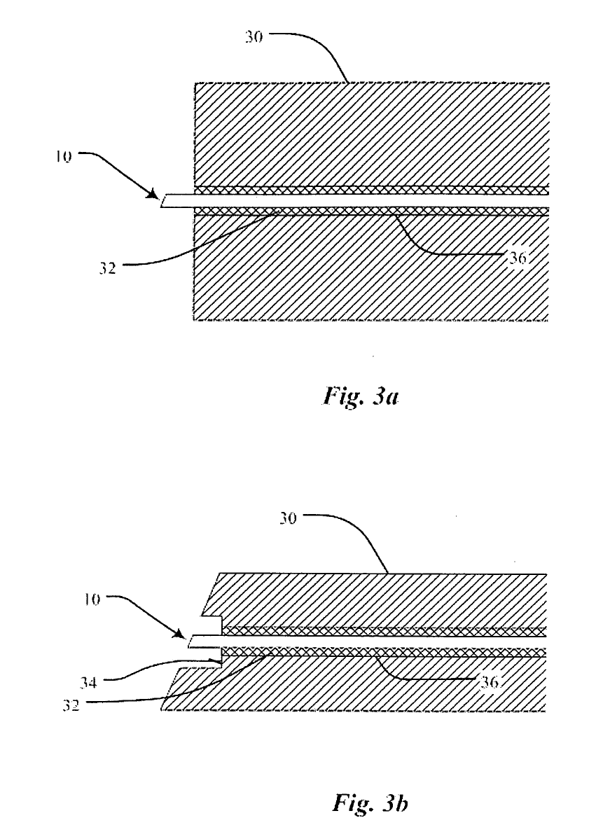

FIG. 3a and FIG. 3b illustrate other embodiments of the fiber-optic termination with Brewster angled tip which is free standing in air, thereby allowing high power coupling and transmission applications. The optical fiber 10 is supported in a holding fixture 30 at a location remote from the laser beam admitting end, thus reducing the level of heat at the holding location. In the specific embodiment illustrated in FIG. 3a, the optical fiber 10 is fixed and extends from a holding fixture 30 to about two to ten times its outside diameter. The optical fiber 10 is inserted into a passageway 36 extending through the holding fixture 30 and glued inside with epoxy 32 or other glue materials. A saw similar to a dicing saw can be used to cut the fiber-optic tip at the proper angle and the proper distance from the holding fixture 30. The saw provides a relatively fine grinding with optical quality finish. This process is simple, fast, very accurate, and provides an effective way to manufacture good optical quality fiber-optic tip at any desired angle. An additional final polish can be applied if necessary to the free standing fiber-optic tip using the abrasive side of the saw blade with micro positioning adjustment. Other polishing techniques with micro positioning adjustment can be applied if necessary to the free standing fiber-optic tip. The holding fixture 30 can be made for example of zirconia or stainless steel ferrules. Also metals like brass, copper and aluminum can be used because of the good thermal conductivity and they are easily machined. In some embodiments, the holding fixture 30 is water cooled to evacuate any heat that can occur at the input end of the optical fiber 10. Thermal conductive epoxy 32 may be used to fix the optical fiber 10 within the holding fixture 30 and to provide good thermal contact.

FIG. 3b is another illustration of a holding fixture 30 where a counterbore 34 forms a central recess or an open annular air gap around the end of the optical fiber 10. In the specific embodiment illustrated in FIG. 3b, a saw can be used to cut simultaneously the fiber-optic tip and the holding fixture 30 at the proper angle. Again, the saw provides a relatively fine grinding with optical quality finish. Additional final polish can be applied if necessary to the free standing fiber-optic tip and the holding fixture 30 using the abrasive side of the saw blade or other polishing techniques with micro positioning adjustment. The holding fixture 30 is made for example of zirconia, stainless steel, brass or other good thermal conductivity materials. In a preferred embodiment, the holding fixture 30 can be water cooled for heat dissipation, and thermal conductive epoxy 32 is used to glue the fiber 10 into the holding fixture 30. The length of the fiber 10 in the counterbore opening 34 is typically the counterbore depth, which is usually two to ten times the outside diameter of the fiber 10. The diameter of the counterbore 34 is typically at least two times the fiber 10 diameter. One advantage to use the counterbore 34 is to provide a better protection for accidentally touching and damaging the fiber 10.

Similarly, the preferred embodiments of the fiber-optic termination with Brewster angled tip which is free standing in air as illustrated in FIG. 3a and FIG. 3b can be used to minimize the reflection of a transmitted polarized light at the exit of an optical fiber. A transmitted polarized light in an optical fiber with the electric field parallel to the plane of incidence, defined by the plane formed with the axis perpendicular to the fiber end face and the axis of the optical fiber, hits the fiber end face at the Brewster angle θ_{B} now defined by (Tan θ_{B}=nₐᵢᵣ/n_{fiber}). Such a transmitted polarized light exits the fiber with no reflection and is refracted in the air according to the law of refraction. Thus, the fiber-optic termination with the Brewster angled tip minimizes the reflection of the transmitted polarized light at the output of an optical fiber.

Interestingly, the fiber-optic termination with Brewster angled tip can be used at both ends of an optical fiber.

People in the art will appreciate that a fiber-optic termination according to the present invention may be used in a number of applications where polarized light is coupled into optical fiber, including for example low and high power beam delivery, fiber lasers and amplifiers, and optical resonant cavities. The present invention may find uses in a range of fields, including military, medicine, and laser welding for example.

Fiber array can be made of multiple fiber-optic terminations with Brewster angled tips. For example a fiber array can be made of a number of fibers glued in a holding fixture in a manner similar to preferred embodiment described in FIG. 3a. A saw similar to a dicing saw can be used to cut the fiber-optic tips at the proper angle and the proper distance from the holding fixture. The saw provides a relatively fine grinding with optical quality finish. An additional final polish can be applied if necessary to the free standing fiber-optic tips using the abrasive side of the saw blade with micro positioning adjustment. Other polishing techniques with micro positioning adjustment can be applied if necessary to the free standing fiber-optic tips. Linear and two dimensional fiber arrays can be made using the present invention and can be used in switching applications for example. It should be mentioned that the above fiber array description can be modified is such a way as the holding fixture contains counterbores in a manner similar to the preferred embodiment described in FIG. 3b to form a recess or an open air gap around the end of the optical fiber tips. The fiber tips and the holding fixture are cut and polished at the same time using a saw similar to a dicing saw. Additional final polish can be applied if necessary to the free standing fiber-optic tips and the holding fixture using the abrasive side of the saw blade or other polishing techniques with micro positioning adjustment. In some embodiments, the holding fixture of the fiber array can be water cooled for heat dissipation, and thermal conductive epoxy can be used to glue the fibers into the holding fixture.

The fiber-optic termination with Brewster angled tip can be used with optical fibers made of various glasses and having a wide range of refractive indices, including for example silica, chalcogenide, fluoride, germanate, sapphire, silver halide, plastic.

The fiber-optic termination with Brewster angled tip can be used with various types of optical fibers and fiber bundles, including for example singlemode, multimode, polarization maintaining, polarizing, rare-earth doped, crystal, special shape.

People in the art will appreciate that the present invention provides a relatively economic, fast and effective alternative to the use of expensive antireflection (AR) coatings for elimination light reflection of a polarized light at the air-glass interface of an optical fiber.

Although the present invention has been described hereinabove by way of specific embodiments thereof, it can be modified, without departing from the spirit and nature of the subject invention as defined in the appended claims.

What is claimed is:

1. A fiber-optic termination, said fiber-optic termination defining a Brewster angled tip.

2. A fiber-optic termination for receiving a light ray emitted by a light source, said fiber-optic termination comprising an optical fiber defining a fiber end face, said fiber end face being angled at a Brewster angle relatively to said light ray.

3. A fiber-optic termination as defined in claim 2, wherein said optical fiber defines a fiber longitudinal axis, said fiber end face being angled relatively to said fiber longitudinal axis such that said light ray is refracted by said fiber end face substantially along said fiber longitudinal axis.
